(19) United States
(12) Patent Application Publication
(10) Pub. No.: US 2006/0241005 A1
(43) Pub. Date: Oct. 26, 2006

(54) Oil-splitting alkaline cleaner for metal parts

(76) Inventors: Elizabeth J. Siebert, Birmingham, MI (US); William E. Fristad, Rochester Hills, MI (US); David C. Montrose, Macomb, MI (US)

Correspondence Address: HENKEL CORPORATION, THE TRIAD, SUITE 200, 2200 RENAISSANCE BLVD., GULPH MILLS, PA, 19406, US

(21) Appl. No.: 11/397,376

(22) Filed: Apr. 4, 2006

Related U.S. Application Data
(60) Provisional application No. 60/668,034, filed on Apr. 4, 2005.

(51) Int. Cl. C11D 3/20

(52) U.S. Cl. 510/245; 510/201

(57) ABSTRACT

This invention relates to alkaline cleaning solutions for hard surfaces, particularly those of metal objects, which are contaminated with oil or similar materials, effective for cleaning oils from hard surfaces that cause separation of the oil in the cleaner and, when contaminated with the aforementioned oils and passed through an ultra or micro filter, the cleaner and the surfactants therein pass substantially completely through the filter membrane into the permeate leaving contaminants in the filter and/or retentate.

### CROSS REFERENCE TO RELATED APPLICATION

This application claims priority from U.S. Provisional Application No. 60/668,034 filed Apr. 4, 2005.

### FIELD OF THE INVENTION

This invention relates to alkaline cleaning solutions for hard surfaces, particularly those of metal objects, which are contaminated with oil or similar materials that are widely used as lubricants in machining and/or as temporary protection against corrosion. More particularly, the invention relates to solutions effective for cleaning oils from hard surfaces that cause separation of the oil in the cleaner and, when contaminated with the aforementioned oils and passed through an ultra or micro filter, the cleaner and the surfactants therein pass substantially completely through the filter membrane into the permeate leaving contaminants in the filter and/or retentate.

### BACKGROUND OF THE INVENTION

The term “alkaline cleaning solutions” as used herein includes all aqueous solutions that contain (i) at least one dissolved alkalinizing constituent, such as alkali or alkaline earth metal hydroxides, carbonates, borates, phosphates, or silicates and (ii) either no off-setting acid or an amount of such acid that leaves the total composition with a pH greater than 8. The borates, phosphates, and silicates in this class include both simple and condensed types, such as metasilicate, pyrophosphate and tripolyphosphate, and borax and the like. The alkali and alkaline earth metals include particularly sodium, potassium, magnesium, calcium, barium, and the like. More particularly this invention relates to such cleaning solutions, and concentrates for making them, that contain hydroxide(s) as the sole or at least the most predominant alkalinizing constituent.

Phosphates are often included as a detergent builder to increase cleaning effectiveness.

Normally, alkaline cleaner compositions now used for metal surface preparation contain a surfactant component, which may be a single chemical type of surfactant or a mixture of such chemical types, including any or all of the classes of anionic, cationic, amphoteric ionic, and nonionic surfactants. (Cationic surfactants are less commonly used than the other types in metal cleaning formulations, because they are more likely to affect the subsequent processing and treatment of the metal surface in some manner that may be adverse.)

In known alkaline cleaners, nonionic surfactants are generally preferred for their cleaning power, which is generally superior to surfactant packages that comprise ionic or amphoteric surfactants, alone. Oily residues on metal surfaces tend to be resistant to cleaning in the absence of nonionic surfactant. This lack of cleaning power of anionic, cationic, amphoteric ionic surfactants became more of a problem when environmental concerns caused the industry to move toward recyclable cleaners, which tend to lose most of their non-ionic surfactants during recycling.

With increasing environmental concerns regarding disposal of used cleaner baths, particularly phosphate cleaners, there is a greater demand for cleaners that can be reused after separation of oily contaminants. An increasingly popular method of cleaning contaminated cleaner baths is the use of ultrafiltration, which comprises passing the contaminated cleaner bath through one or more filters having membranes with a pore size of 0.005 to 0.15 microns, filtering out oil into a retentate and recovering the cleaner in the permeate. Early attempts to filter typical cleaner baths used in washing hard surfaces met with several obstacles, one being the retention of a large percentage of the cleaner's surfactant package by the filter membrane and the removal of non-permeable surfactant with the concentrated oily contaminants. It was found that only some surfactants could pass through the ultra filter membrane. Filtration of the cleaner bath often resulted in a permeate that lacked some or all of the surfactant found in the original cleaner. The cleaning performance of the bath declined with filtration unless the relatively expensive surfactants were replenished. This however added unwanted cost to the process.

Attempts have been made in the prior art to provide processes for recovering nonionic, ionic or amphoteric surfactants, with various degrees of success. It is known in the art that typical nonionic surfactants, at working cleaner bath temperatures, do not efficiently permeate ultrafilters. While anionic and to a certain extent amphoteric surfactants pass through the ultrafilter membrane into the permeate, their cleaning performance has not equaled that of the non-ionic surfactants.

Another problem that must be addressed in maintaining surfactant concentrations in a filterable cleaner is the loss of the surfactant in oil that is cleaned from metal parts. Solubilization of surfactants in the oil and association of surfactants with emulsified oil can be appreciable; nonionic surfactants are particularly susceptible to separation from the other cleaner components. Thus the most effective surfactants for cleaning oily residues tend to be the most problematic when attempting to recycle the cleaner baths.

Although patents on surfactants (nonionic, amphoteric and anionic) for use in ultrafilterable cleaners exist, the data furnished in the patents shows only dilute surfactant solutions passing through the ultrafiltration membranes. Testing of a formulated cleaner, that is a cleaner including a dissolved alkalinizing constituent, and optionally phosphate, which can alter surfactant filterability, comprising these surfactants for the ability to pass through an ultrafilter without loss of the majority of the cleaner's surfactant package has not been demonstrated. Surfactants are known to behave differently depending on the temperature and the pH, thus passing a dilute surfactant solution through a microfilter does not establish that the same surfactant in a formulated alkaline cleaner would pass through a microfilter.

While some amphoteric surfactants have been shown to permeate effectively through ultrafiltration membranes, cleaners formulated with amphoteric surfactants have not been shown to effectively clean metals. A drawback of these prior art attempts and the cleaner baths disclosed therein is that they do not clean oily residues from metal parts as well as is desired. Nonionic cleaners are known in the art as having excellent oil cleaning properties, but do not pass into the permeate with any efficiency, that is, the non-ionic surfactants do not pass through the filter effectively.

Thus, there is a need for a cleaner containing a combination of surfactants that provides adequate cleaning of oily residues from metal surfaces, and passes through the ultrafilter membrane into the permeate substantially completely.

### SUMMARY OF THE INVENTION

One major objective of the invention is to provide an alkaline, if desired very strongly alkaline, aqueous cleaning composition and/or a surfactant combination therefor, with cleaning power at least as good as that achieved by conventional prior art compositions but with the added feature of being recoverable from a contaminated cleaning bath by filtering with an ultra- or micro-filter with the various surfactant components of the cleaning composition passing substantially completely into the permeate. Other objectives will appear from the description below.

It has been found that a cleaning composition comprising a mixture including only charged components that is components having an ionic or amphoteric character will pass through ultra- and micro-filters as part of the permeate. It is known that nonionic surfactants are only partially permeable and thus it is preferred that the amount of nonionic surfactant included in the cleaner be minimized.

Preferred combinations of particular types of ionic surfactants, namely anionic surfactants, with a particular type of amphoteric surfactants, were found to achieve good cleaning power with acceptably low foaming in moderately to strongly alkaline aqueous cleaning compositions. The addition of certain chelating agents was beneficial in improving cleaning efficiency. These cleaning compositions can be recovered from a cleaning bath contaminated with oil, oily soils and the like by ultra-, micro-filtration and/or allowing the bath to remain unagitated for a period of time such that the bath phase separates into an oily phase and an aqueous phase; the aqueous phase may optionally be ultrafiltered after separation. Further, the mixture has sufficient solubility to permit formulation of stable one-package liquid concentrates with up to 25% free alkalinity that are stable for up to one year.

It is an object of the invention to provide a stable, aqueous, alkaline cleaner concentrate composition comprising: (a) an alkali metal hydroxide alkalinizing agent in an amount of at least 1 mole of hydroxide per kilogram of total concentrate composition; (b) an anionic surfactant; (c) an amphoteric surfactant; (d) a sequestering agent and/or a chelating agent; (e) a phosphate builder; and (f) optionally, an antifoam agent, wherein each of components (a) to (f) in aqueous solution is charged and able to pass substantially completely through a filter membrane having a pore size of 0.005 to 0.15 microns. Substantially completely passing through the ultrafilter membrane will be understood by those of skill in the art to mean that at least 50, 55, 60, 65, 70, 75, 80 85, 90, 95, 97, 98, 99 weight percent of the cleaner components in a working bath, including surfactants, pass through the ultrafilter membrane into the permeate.

In one embodiment of the invention, the amphoteric surfactant comprises butylether hydroxypropyl sultaines, ethylhexylether hydroxypropyl sultaines, and mixtures thereof. In this embodiment, the sequestering agent may be selected from the group consisting of organophosphonates, sorbitol, mannitol, gluconates, citrates, heptogluconates, ethylene diamine tetraacetic acid, nitrilotriacetic acid and mixtures thereof.

It a preferred embodiment, the alkalinizing agent is an alkali metal hydroxide, the sequestering agent comprises an organophosphonate and a gluconate, the anionic surfactant is a modified ethoxylated anionic surfactant, and the amphoteric surfactant is a sultaine.

It is another aspect of the invention that the stable, aqueous alkaline cleaner concentrate composition has sufficient solubility of (a) to (f) in aqueous solution of up to 25% free alkalinity such that a one-package liquid concentrate is stable for at least 3 months, preferably at least 6 months, most preferably at least one year.

In one embodiment of the invention, the stable, aqueous, alkaline cleaner concentrate composition comprises: (a) the alkali metal hydroxide alkalinizing agent in an amount of 1.5 to 5.0 mole of hydroxide per kilogram of total concentrate composition; (b) the anionic surfactant in an amount of 0.5 to 20 wt %; (c) the amphoteric surfactant in an amount of 0.5 to 20 wt %; (d) the sequestering agent and/or chelating agent in an amount of 0.1 to 20 wt %; (e) the phosphate builder in an amount of to 2 to 30 wt %; and (f) optionally, an antifoam agent.

In another aspect of the invention, a working cleaner bath is made-up by adding the alkaline cleaner composition concentrate of the invention to water in an amount sufficient to provide the bath with 0.5 to 10.00 wt % concentration of the alkaline cleaner composition concentrate.

It is yet another aspect of the invention to provide a stable, aqueous, alkaline cleaner composition comprising: (a) an alkali metal hydroxide alkalinizing agent in an amount sufficient to provide the total composition with a pH greater than 8; (b) an anionic surfactant; (c) an amphoteric surfactant; (d) a sequestering agent and/or a chelating agent; (e) a phosphate builder; and (f) optionally, an antifoam agent; wherein the anionic surfactant is a modified ethoxylated anionic surfactant, the amphoteric surfactant is a sultaine and (b) to (c) are present in a ratio in the range of 3:6 to 2:1. In one embodiment of the invention the stable, aqueous, alkaline cleaner composition comprises: (a) an alkali metal hydroxide alkalinizing agent in an amount of 0.07 to 4.0 moles of hydroxide per kilogram of total concentrate composition; (b) an anionic surfactant in an amount of 0.03 to 4.0 wt %; (c) an amphoteric surfactant in an amount of 0.04 to 6.5 wt %; (d) a sequestering agent and/or a chelating agent in an amount of 0.06 to 7.5 wt %; (e) a phosphate builder in an amount of 0.15 to 17.0 wt %. In a preferred embodiment of the stable, aqueous, alkaline cleaner composition, the amphoteric surfactant comprises butylether hydroxypropyl sultaines, ethylhexyl ether hydroxypropyl sultaines and mixtures thereof. In another aspect of the invention, the sequestering agent is selected from the group consisting of organophosphonates, sorbitol, mannitol, gluconates, citrates, heptogluconates, ethylene diamine tetraacetic acid, nitrilotriacetic acid and mixtures thereof.

In a different aspect the invention provides a cleaning system comprising recyclable cleaner, said system comprising:
a cleaner bath containing an alkaline cleaner comprising: (a) an alkali metal hydroxide alkalinizing agent in an amount of at least 0.35 mole of hydroxide per kilogram of total concentrate composition; (b) an anionic surfactant; (c) an amphoteric surfactant; (d) a sequestering agent and/or a chelating agent; (e) a phosphate builder; and (f) optionally, an antifoam agent;
a filter membrane in fluid communication with the cleaner bath, having a pore size of 0.005 to 0.15 microns, through which the alkaline cleaner passes thereby generating a permeate and a retentate;
wherein the surfactants are selected such that permeate surfactant concentration is at least 50% of retentate surfactant concentration at a given point in time after at least a portion of the alkaline cleaner has been filtered. In one embodiment, the cleaning system, further comprises a permeate receiving unit and a retentate receiving unit. In a preferred embodiment of the cleaning system, the surfactants are selected such that surfactant concentration of the permeate is at least 70% of surfactant concentration of the retentate at a given point in time after at least a portion of the alkaline cleaner has been filtered.

Except in the claims and the operating examples, or where otherwise expressly indicated to the contrary, all numerical quantities in this description indicating amounts of material or conditions of reaction and/or use are to be understood as modified by the word “about” in describing the broadest scope of the invention. Practice within the numerical limits stated is generally preferred, however. Also, throughout the description and claims, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; specification of materials in ionic form implies the presence of sufficient counterions to produce electrical neutrality for the composition as a whole, and any counterions thus implicitly specified preferably are selected from among other constituents explicitly specified in ionic form, to the extent possible; otherwise such counterions may be freely selected, except for avoiding counterions that act adversely to the objects of the invention; and the term “mole” and its variations may be applied to ionic, chemically unstable neutral, or any other chemical species, whether actual or hypothetical, that is specified by the type(s) of atoms present and the number of each type of atom included in the unit defined, as well as to substances with well defined neutral molecules.

### DETAILED DESCRIPTION OF A PREFERRED EMBODIMENT

This invention relates to alkaline cleaners, for removing oil or similar materials from hard surfaces, that comprise a surfactant package selected such that when dirty cleaner, contaminated with oils, soils and the like, is passed through an ultra or micro filter, the cleaner and the surfactants therein pass substantially completely through the filter membrane into the permeate leaving contaminants in the filter and/or retentate. In a preferred embodiment, the alkaline cleaners of the invention cause separation of the contaminating oil in the cleaner, thereby facilitating removal of the oil.

One embodiment of the invention is an aqueous liquid composition that is suitable, as such, after dilution with water, or both as such and after dilution with water, for cleaning hard surfaces, such as metal substrates, particularly steel and galvanized steel surfaces. This composition comprises, preferably consists essentially of, or more preferably consists of, water and:

(a) an alkali metal hydroxide alkalinizing agent;

(b) an anionic surfactant;

(c) an amphoteric surfactant;

(d) a sequestering agent and/or a chelating agent;

(e) a phosphate builder; and

(f) optionally, an antifoam agent

wherein each of components (a) to (f) in aqueous solution is charged and able to pass substantially completely through a filter membrane having a pore size of 0.005 to 0.15, preferably 0.05 to 0.125, most preferably 0.1 microns.

Preferred alkalinizing agents for component (A) include ammonium, sodium, and potassium hydroxides, with the latter two more preferred. Both of these appear substantially equal in promoting cleaning. Sodium hydroxide is usually less expensive but also forms less soluble salts with almost any acidic material that might be added to the composition and/or is less tolerant of non-electrolytes in mutual aqueous solution with it, so that at least some potassium hydroxide is normally preferred for very strong concentrates according to the invention. In one specific preferred embodiment, only potassium and/or sodium hydroxide(s) are used for component (A).

Independently of other preferences, in a concentrate composition according to the invention, the amount of dissolved hydroxide in component (A) is such as to provide at least, with increasing preference in the order given, 1.0, 2.0, 3.0, 3.5, 3.8, 4.1, 4.4, 4.7, or 5.0 moles of OH⁻ per kilogram of total concentrate composition. The total stoichiometric equivalent as hydroxide ions of all soluble alkali metal and alkaline earth metal hydroxides dissolved in the composition is to be considered as dissolved OH⁻ for determining whether these preferential values are achieved, except when acids or other reagents known to be rapidly reactive with aqueous hydroxide ions are also added to the compositions; in such an instance, only the net remaining hydroxide ions after theoretically complete neutralization or other rapid reaction of such added reagents are considered to be dissolved OH⁻. In a working composition according to the invention, the concentration of dissolved hydroxide ions preferably is from 0.5 to 10.0%, preferably 0.5 to 5%, of the concentrations stated earlier in this paragraph to be preferred for concentrate compositions.

Generally, a working bath of the composition is made-up by adding cleaner composition concentrate to water in an amount sufficient to provide a bath having 0.5 to 10.00 wt % of the concentrate therein, preferably 0.5-5.0 wt %. Alternatively, a bath may be made-up by addition of each component individually. In either case, the various components in the working bath are typically present in amounts equal to 0.5-10.00 wt %, of the amount of the component found in the cleaner concentrate as disclosed herein.

Suitable anionic surfactants for use as component (B) include known anionic surfactants that are stable in strongly alkaline solutions and which pass substantially completely through an ultrafilter membrane into the permeate. The anionic surfactant is, desirably, compatible with other anionic and amphoteric surfactants and other components of the cleaner. It is also desirable that the anionic surfactant is a low or non-foaming surfactant, particularly for spray applications, where foaming is particularly undesirable. Examples of anionic surfactants useful in the invention include modified ethoxylated anionic surfactants, such as Triton DF-20 sold by Dow Chemical, Midland, Mich.; phosphate esters of polyether polyols, such as Triton H-66 also sold by Dow Chemical. The concentration of anionic surfactants in a concentrate composition according to the invention preferably is at least, with increasing preference in the order given, 0.5, 1.0, 1.5, 2.0, 2.5, 3.0, 3.5, 4.0, 4.5% and independently, primarily for reasons of economy, is not more than, with increasing preference in the order given, 20, 15, 14, 13, 12, 11, 10, 9.0, 8.0, 7.0, 6.0, 5.0%.

Amphoteric surfactants suitable for use as component (C) include amphoteric surfactants that are stable in strongly alkaline solutions and which pass substantially completely through an ultrafilter into the permeate. The amphoteric surfactant is, desirably, compatible with other anionic and amphoteric surfactants and other components of the cleaner. It is also desirable that the amphoteric surfactant is a low or non-foaming surfactant, particularly for spray applications, where foaming is particularly undesirable. Examples of amphoteric surfactants useful in the invention include sulfonated wetting agents, imidazoline-based amphoteric molecules, such as mono acetates and dipropionates; betaines; sultaines, such as butylether hydroxypropyl sultaines, ethylhexylether hydroxypropyl sultaines, such as 2-ethylhexylether hydroxypropyl sultaine, and mixtures thereof. Illustrative examples of sultaines that can be used in practicing the invention are disclosed in U.S. Pat. No. 4,891,159, which is hereby incorporated by reference. The preferred sultaines are alkylether hydroxylpropyl sultaines.

The concentration of amphoteric surfactants in a concentrate composition according to the invention preferably is at least, with increasing preference in the order given, 0.5, 1.0, 1.5, 2.0, 2.5, 3.0, 3.5, 4.0, 4.5% and independently, primarily for reasons of economy, is not more than, with increasing preference in the order given, 20, 15, 14, 13, 12, 11, 10, 9.0, 8.0, 7.0, 6.0, 5.0%.

Suitable sequestering agents for component (D), which are not part of any of the above-identified components include those known in the art which are compatible with anionic and amphoteric surfactants and other components of the cleaner. Examples include organophosphonates, including amine-containing phosphonates, such as amino tri(methylene phosphonic acid); commercially available examples of the organophosphonates include Dequest 2000 and 2010. Other suitable sequestering agents include sorbitol, mannitol, gluconates, citrates, heptogluconates, ethylene diamine tetraacetic acid (“EDTA”), nitrilotriacetic acid (“NTA”), and other water soluble organic compounds containing at least two carboxyl, carboxylate, and/or hydroxyl moieties, the last being exclusive of hydroxyl moieties that are part of carboxyl moieties, that are separated from one another within the molecule by at least two, more preferably by exactly two or three, other atoms that are not part of the carboxyl, carboxylate, or hydroxyl moieties, along with the salts, particularly the potassium and sodium salts, of all of the compounds previously recited in this paragraph that are acids. Gluconates, and/or organophosphonates are preferred. The concentration of sequestering agents in a concentrate composition according to the invention preferably is at least, with increasing preference in the order given, 0.1, 0.3, 0.5, 1.0, 1.5, 2.0, 2.5, 2.9% and independently, primarily for reasons of economy, is not more than, with increasing preference in the order given, 20, 15, 10, 8.0, 7.0, 6.0, 5.0, 4.5, 4.1, 3.9, 3.7, 3.5%.

Phosphate builders suitable for use as component (E) include those known in the art which do not interfere filtration of the cleaner and which pass substantially completely through an ultrafilter into the permeate. The phosphate builder is also, desirably, compatible with anionic and amphoteric surfactants and other components of the cleaner. Illustrative examples of phosphate builders that can be used in practicing the invention include tetrapotassium pyrophpsphate (TKPP), tripotassium phosphate (TKP) and trisodium phosphate (TSP). The concentration of phosphate builder in a concentrate composition according to the invention preferably is at least, with increasing preference in the order given, 2, 4, 6, 8, 10, 12, 14, 15, 16, 17% and independently, primarily for reasons of economy, is not more than, with increasing preference in the order given, 30, 25, 20, 19%.

Suitable antifoam agents for optional component (F) include those known in the art which do not otherwise interfere with the cleaning ability of the composition and which substantially completely pass through an ultrafilter. The amount of antifoaming agent used in the composition is not critical provided it is sufficient to decrease foaming to an acceptable level. Selection of the types and amounts of antifoaming agent to be used in an embodiment of the invention is within the knowledge and skill of one of ordinary skill in the art requiring minimal testing.

Preferably, to avoid environmental pollution and for other varied reasons, compositions according to the invention preferably contain, independently for each preferably minimized component stated below, not more than, with increasing preference in the order given, 5.0, 3.0, 1.0, 0.5, 0.2, 0.10, 0.05, 0.02, 0.01, 0.005, 0.002, 0.001, 0.0005, 0.0002, 0.0001, 0.00005, 0.00002, or 0.00001 percent of any of: nitrogen, and any material that (i) is not part of one of the necessary or optional components stated above and (ii) is regulated under U.S. law as a “Volatile Organic Compound”.

Cleaning according to the invention may be performed by any method which brings soiled hard surfaces to be cleaned into contact with a liquid working cleaning composition according to the invention for a sufficient time to transfer at least part of the soil on the hard surface into the liquid working cleaning composition, then removing the surface to be cleaned from contact with the liquid working cleaning composition, and, optionally but usually, rinsing the cleaned surface with water to remove any adherent cleaning composition. Preferably, during contact between a surface to be cleaned and a composition according to the invention, the temperature of the composition according to the invention is at least, with increasing preference in the order given, 30, 35, 40, 45, 50, 55, or 60.degree. C. and independently, primarily for reasons of economy, preferably is not more than, with increasing preference in the order given, 90, 85, 80, 75, 70, or 65.degree. C. Spraying the surfaces to be cleaned with a working cleaning composition is generally preferred to other methods of contacting these surfaces, because the mechanical action of spray impingement aids in rapid transfer of soils into the liquid cleaner.

After use, the cleaner becomes contaminated with oils, soils and other substances removed from the metal surfaces cleaned. The contaminated cleaner may be disposed of, as known in the prior art, or preferably the contaminated cleaner is recycled. Recycling of the cleaner according to the invention is accomplished by passing the contaminated cleaner through an oil separation device, such as an oil coalescing unit, and/or an ultrafiltration unit. In the absence of agitation, cleaners of the invention show phase separation of the contaminated cleaner bath into an oily contaminant phase and an aqueous phase. This feature is known as oil-splitting in the industry and is useful in facilitating the drawing off of the oily contaminant in a manner known in the art, such as by way of non-limiting example, by using an oil coalescing unit. Drawing off of the oily contaminant phase can be used alone or as a pretreatment prior to ultrafiltration of the contaminated cleaner. In ultrafiltration, the oils, soils and other substances washed off of the surfaces cleaned and into the cleaner do not pass through the ultrafilter membrane, but are instead retained by the ultrafilter and concentrated in a retentate tank. The cleaner according to the invention permeates through the ultrafilter membrane and is returned to the working cleaner bath for reuse. A critical feature of the cleaners of the invention is a surfactant package, meaning the mixture of surfactants in the cleaner, that passes substantially completely through the ultrafilter membrane as permeate and can be recycled into the cleaner bath.

In a preferred embodiment, the contaminated cleaner is allowed to rest for a selected period of time sufficient to allow splitting of the contaminated cleaner into two or more phases and the oily phase is drawn off before ultrafiltration. Typically, cleaners according to the invention split oil and oily soils into an oil phase and a cleaner phase if left unagitated. The length of time required for phase separation depends on the amount of oil in the cleaner, the type and length of prior agitation and the method of use of the cleaner, e.g. spraying, dipping or other application method. Determining the separation time desired in a particular application is within the knowledge and experience of one of ordinary skill in the art requiring little experimentation. The cleaner phase is then withdrawn and passed through an ultrafilter; alternatively, the oil phase, generally floating on top of the cleaner phase may be removed and the cleaner phase passed through the ultrafilter.

Further appreciation of the present invention may be had from the following examples and comparison examples which are intended to illustrate, but not limit, the invention.

### EXAMPLES

Cleaner concentrates according to the invention and comparative examples of commercially available cleaner concentrates were formulated as recited in Table 1:

TABLE 1

| Amount in | Example | Example | Comparative | Comparative |
|---|---|---|---|---|
| weight % | 1 | 2 | Example 1 | Example 2 |
| KOH 45% (aq) | 43.9 | 43.9 | 43.9 | 48.5 |
| Triton H-66 | 2.0 | | | |
| (anionic | | | | |
| surfactant) | | | | |
| Triton DF-20 | 1.0 | 3.0 | 3.0 | 2.5 |
| (anionic | | | | |
| surfactant) | | | | |
| Polyoxypropylene- | | | 1.0 | 0.5 |
| polyoxyethylene | | | | |
| block copolymer | | | | |
| (nonionic | | | | |
| surfactant) | | | | |
| Ethoxylated, | | | | 1.5 |
| substituted phenol | | | | |
| Alkylether | 4.7 | 4.7 | | |
| hydroxyalkyl | | | | |
| sultaine | | | | |
| (Amphoteric | | | | |
| surfactant) | | | | |
| Organophosphonate | 4.0 | 4.0 | | |
| sequestering agent | | | | |
| Sodium Gluconate | 2.0 | 2.0 | 1.0 | 2.0 |
| TKPP 60% (aq) | 33.3 | 33.3 | 33.3 | 8.3 |
| Water | Remainder | Remainder | Remainder | Remainder |

### Example I

The cleaner formula of Example 1 was compared for cleaning ability with two commercially available cleaners Comparative Examples 1 and 2. Working cleaner baths were prepared containing 3 wt % of a cleaner concentrate formulated according to the formulations listed in Table 1. The working cleaner bath of Example 1 was used fresh and after ultrafiltering the cleaner bath for a sufficient time to result in a turn over of the bath ˜1.6 times. Ultrafiltration was performed using an ultrafiltration unit having a single filter membrane commercially available from Graver having a pore size of nominally 0.1 micron. ACT CRS panels that were heavily-oiled (Quaker 61-AUS oil applied with a #5 draw-down bar) and oven-aged (5 days@120° F.) were placed in their respective baths for 2 minutes at 140° F. The panels were removed from their baths, rinsed with tap water and assessed for water breaks. Water breaks, if present, indicate incomplete cleaning of the panel. No water breaks were observed for any of the test panels. The panels were also wiped with a white cloth to check for smut and soil. No smut or soil was observed on any of the cloths used to test wipe the cleaned panels. The Example 1 cleaner, both fresh and after ultrafiltration, cleaned panels as well as Comparative Examples 1 and 2.

### Example II

A cleaner bath from concentrate according to Example 1 was compared for cleaning ability with Comparative Example 1 and a commercially available cleaner concentrate (Comparative Example 3), which contained 40 wt % KOH 45% (aq.), 2.5 wt % Triton DF-20 anionic surfactant, 16 wt % NaOH 50% (aq.), 3.5 wt % sodium gluconate and 1.0 wt % octylphenoxy polyethoxy ethanol. Each of the three cleaner concentrates was used to make-up separate working baths containing 3 wt % of one of the cleaner concentrates. The baths were tested fresh and with various levels (0.5-5.0 wt %) of Quaker 61 AUS oil added to the bath. ACT CRS panels were submerged in their respective cleaner baths for 2 minutes at 140° F., removed from the bath, rinsed with tap water, zinc phosphated using Bonderite® 958 for 2 minutes at 120° F., allowed to dry and then sent for powder painting at ACT using commercially-available Sunburst Yellow powder paint (402016). Physical and corrosion testing of the panels cleaned with oil loaded and fresh cleaner was done according to known ASTM testing methods: Crosshatch Adhesion (ASTM D3359, Method B); Water-Soak Adhesion (ASTM D870); Salt spray (ASTM B117); Humidity (ASTM D1735); Film Build was measured with an Elcometer. The results are summarized in Table 2. For direct impact, a larger number indicates better performance; for the crosshatch test, 5B indicates no coating loss; for the water soak and humidity testing the lower the numbers the better; for salt spray, the number is creepage from the scribe line in mm and a lower number indicates better salt spray resistance.)

TABLE 2

| | | | | | | | Salt | Salt |
|---|---|---|---|---|---|---|---|---|
| | | Film | | Cross- | W. Soak | Humidity | Spray | Spray |
| | Oil | Build | Direct/Rev | hatch | (240 Hrs) | (1008 Hrs) | (504 | (1008 |
| Cleaner | Loading | (mils) | Impact | Adhesion | Blister/Rust | Blister/Rust | Hrs) | Hrs) |
| Comp. | 0 | 2.8 | 80/110 | 5B | 0/0 | 0/0 | 1.3 | 2.1 |
| Ex. 1 | | | | | | | | |
| Comp. | 0.5 | 2.9 | 90/120+ | 5B | 0/0 | 0/0 | 1.4 | 2.1 |
| Ex. 1 | | | | | | | | |
| Comp. | 1 | 3.0 | 80/120+ | 5B | 0/0 | 0/0 | 1.2 | 2.1 |
| Ex. 1 | | | | | | | | |
| Comp. | 2 | 2.7 | 90/120+ | 5B | 0/0 | 0/0 | 1.5 | 2.2 |
| Ex. 1 | | | | | | | | |
| Comp. | 3 | 2.9 | 90/75 | 5B | 0/0 | 0/0 | 1.6 | 1.8 |
| Ex. 1 | | | | | | | | |
| Comp. | 5 | 2.9 | 90/120+ | 5B | 0/0 | 0/0 | 1.7 | 1.4 |
| Ex. 1 | | | | | | | | |
| Comp. | NA | 2.9 | 87/111+ | 5B | 0/0 | 0/0 | 1.5 | 2.0 |
| Ex. 1 | | | | | | | | |
| Average | | | | | | | | |
| Comp. | 0 | 2.7 | 120+/120+ | 5B | 0/0 | 0/0 | 1.5 | 1.7 |
| Ex. 3 | | | | | | | | |
| Comp. | 0.5 | 2.6 | 90/120 | 5B | 0/0 | 0/0 | 1.6 | 2.0 |
| Ex. 3 | | | | | | | | |
| Comp. | 1 | 2.5 | 80/120+ | 5B | 0/0 | 0/0 | 1.6 | 1.6 |
| Ex. 3 | | | | | | | | |
| Comp. | 2 | 2.8 | 90/90 | 5B | 0/0 | 0/0 | 1.5 | 1.7 |
| Ex. 3 | | | | | | | | |
| Comp. | 3 | 2.9 | 110/90 | 5B | 0/0 | 0/0 | 1.4 | 1.4 |
| Ex. 3 | | | | | | | | |
| Comp. | 5 | 2.8 | 90/120+ | 5B | 0/0 | 0/0 | 1.8 | 2.1 |
| Ex. 3 | | | | | | | | |
| Comp. | NA | 2.7 | 97/110+ | 5B | 0/0 | 0/0 | 1.6 | 1.8 |
| Ex. 3 | | | | | | | | |
| Average | | | | | | | | |
| Ex. 1 | 0 | 2.8 | 90/120+ | 5B | 0/0 | 0/0 | 1.6 | 2.2 |
| Ex. 1 | 0.5 | 2.9 | 70/90 | 5B | 0/0 | 0/0 | 1.5 | 2.4 |
| Ex. 1 | 1 | 2.9 | 90/120+ | 5B | 0/0 | 0/0 | 1.4 | 2.1 |
| Ex. 1 | 2 | 2.7 | 100/120+ | 5B | 0/0 | 0/0 | 1.4 | 2.3 |
| Ex. 1 | 3 | 2.8 | 90/120+ | 5B | 0/0 | 0/0 | 1.3 | 2.4 |
| Ex. 1 | 5 | 2.9 | 110/110 | 5B | 0/0 | 0/0 | 1.7 | 2.2 |
| Ex. 1 | NA | 2.8 | 92/113+ | 5B | 0/0 | 0/0 | 1.5 | 2.3 |
| Average | | | | | | | | |

### Example III

A cleaner bath using 3 wt % cleaner concentrate according to Example 1 was made-up. Another cleaner bath using 3 wt % cleaner concentrate according to Comparative Example 1 was made-up. Quaker 61 AUS oil was added to each bath to an oil amount of 0.5 wt %. The baths were heated to 140° F. Each bath was filtered using an ultrafiltration unit as described above and the amount of surfactant was measured in the permeate (liquid that passed through the ultrafilter membrane), the retentate (matter that did not pass through the ultrafilter membrane) and the cleaner bath. The ultrafiltration unit used was plumbed to return the permeate to the cleaner bath and to deliver the retentate to a retentate tank.

For a 3 wt % working cleaner bath of Comparative Example 1, approximately 40% of the nonionic surfactant, Pluronic L-61, was removed in ultrafiltering the cleaner bath for ˜85% of a theoretical bath turnover (no added replenisher). If surfactant was being replenished to keep its concentration constant, then ˜70% of the total surfactant would be removed from the cleaner bath, based on permeate samples. Comparing the surfactant in the 256-liter cleaner bath with that in the 10-liter retentate tank, only 85% of the removed surfactant was accounted for in the aqueous phases. Approximately 15% of the surfactant was presumed to remain in the oil phases. Since the emulsified oils are stable, the associated surfactant was lost or extracted into the increasing oil phase in the retentate tank. Overall, appreciable nonionic surfactant was lost and needed to be replenished in order to maintain cleaning.

For a 3 wt % working cleaner bath of Example 1, the surfactant concentration was the same in the cleaner bath and permeate tank. The Example 1 cleaner readily split off the oil and formed two distinct layers in the retentate tank. No surfactant appears to have been dissolved into the oily phase. The only surfactant that would need to be replaced would be due to cleaner drag-out.

The overall oil removed in 85-90% of a bath turnover was approximately 20% for both cleaners.

### Example IV

An ultrafiltration unit containing a 6-tube ultrafiltration module containing membranes having a nominal pore size of 0.1 microns commercially available from Graver Technologies was used. The ultrafiltration unit used was plumbed to return the permeate to the cleaner bath and to deliver the retentate to a retentate tank where the contents of the tank were allowed to separate into an aqueous phase for which was refiltered and an oily phase to be drawn off. The ultrafiltration unit was connected to a 256-liter cleaner tank containing a working cleaner bath, containing 2 wt % Example 2, maintained at a temperature of 140° F. and baseline measurements (1) and (2) were taken. 0.5% Quaker 61-AUS oil was added to the bath and the cleaner bath was turned over 2.9 times; the permeate remained clear. To determine conditions where the permeate would turn cloudy, the retentate tank (containing ˜10% removed oil) was vigorously mixed and the permeate stream turned cloudy, see measurements (3) and (4). Agitation of the retentate tank was ceased and after 30 minutes the permeate was again clear, see measurement (5). The results of ICP sulfur analysis for amphoteric surfactant are shown below and verify that the amphoteric surfactant permeates through this 6-column membrane.

TABLE 3

| | | | | | | | Amphoteric | | Oil | |
|---|---|---|---|---|---|---|---|---|---|---|
| | | | | | | | Surfactant | | Content | |
| | | | | | Oil | | ICP | | Oil | |
| | % Bath | Sample | Appearance | | Added to | | Sulfur | % Surf. | Split | % |
| # | Turnover | Description | Oil | Aqueous | Cleaner | Phase | (ppm) | Retained | (mls) | Oil |
| 1 | 0% | Permeate | NA | Clear | 0% | Aqueous | 70 | 100% | NA | 0% |
| 2 | 0% | Cleaner | NA | | 0% | Aqueous | 70 | 100% | NA | 0% |
| | | Tank | | | | | | | | |
| | | (Baseline) | | | | | | | | |
| 3 | 2.9% | Retentate | Red, | Purple, | 0.5% | Aqueous | 100 | 100% | 8 | 10% |
| | | | Cloudy | Clear | | | | (oil | | |
| | | | | | | | | contains | | |
| | | | | | | | | S) | | |
| 4 | 2.9% | Permeate | NA | Cloudy | 0.5% | Aqueous | 70 | 100% | 0 | ˜0% |
| 5 | 2.9% | Permeate | NA | Clear | 0.5% | Aqueous | 60 | ˜100% | | |
| | | (after 30 | | | | | | | | |
| | | min) | | | | | | | | |

### Example V

Comparative data was gathered in an industrial pretreatment line by using the commercially available alkaline cleaner of Comparative Example 1 as a control for comparison with Example 1 of the invention. At the industrial site, a pretreatment line was equipped with two spray cleaning stages. CRS panels were sprayed for _ minutes in Cleaner Stage 1 and without intermediate rinsing were sprayed for _ minutes in Cleaner Stage 2. The panels were then rinsed, contacted with Bonderite NT-1, a metal pretreatment commercially available from Henkel Corporation and subsequently painted using a commercially available E-coat.

Both cleaners' surfactant amounts were measured initially and in the permeate and retentate after ultrafiltration, see Table 4 and 5.

Two different ultrafiltration units were used to filter each cleaner: A commercially available unit (Unit 1) from Arbortech Corporation having an ultrafiltration module containing membranes with a nominal pore size of 0.1 microns was used. The second unit (Unit 2) used was the same as that for Example IV.

Each ultrafiltration unit was connected to a tank containing a working cleaner bath of the respective cleaner being tested, maintained at a temperature of 135° F. Each ultrafiltration unit used was plumbed to return the permeate to a permeate tank and to deliver the retentate to a retentate tank where the contents of the tank were allowed to separate into an aqueous phase which was refiltered and an oily phase to be drawn off. Example 1 and Comparative Example 1 cleaners from Stages 1 and 2 were each filtered separately for each ultrafiltration unit.

TABLE 4
Comparative Example 1

| | | | | | | | | | | | Nonionic |
|---|---|---|---|---|---|---|---|---|---|---|---|
| | | | | | | CALC | | | | | Surfactant |
| CLEANER/ | | | UF | UF/Coalescer | | CLEANER | FA (10 ml | TA (10 ml | P | S | Titration. |
| CHEMICAL | STAGE | UF | UNIT | Stage | APPEARANCE | CONC. | sample) | sample) | (ICP) | (ICP) | (ml) |
| BASELINE | 1 | NA | NA | NA | Clear yellow, | 2.9 | 14.6 | 44 | NA | NA | 2.9 |
| | | | | | black solid on | | | | | | |
| | | | | | btm; floating oil | | | | | | |
| BASELINE | 2 | NA | NA | NA | Clear yellow, | 2.0 | 9.9 | 28.2 | NA | NA | 1.9 |
| | | | | | black solid on | | | | | | |
| | | | | | btm; floating oil | | | | | | |
| Control | Water | NA | NA | NA | Clear, colorless, | 0.0 | 0.2 | 0.7 | NA | NA | 0.1 |
| | | | | | sl grey solid on | | | | | | (0.1 for DI) |
| | | | | | bottom | | | | | | |
| 1A | 2 | UF | 1 | Permeate | Clear, lt. Yellow | 2.4 | 12.1 | 28.5 | NA | NA | 0.5 |
| 1B | 2 | UF | 1 | Retentate | Clear, yellow, | 1.8 | 8.8 | 30.3 | NA | NA | 12.5 |
| | | | | | black solid on | | | | | | |
| | | | | | btm; floating oil | | | | | | |
| 2B | 2 | UF | 2 | Feed - | Clear, yellow, | 1.8 | 8.9 | 28 | NA | NA | 4.1 |
| | | | | Retentate | black solid on | | | | | | |
| | | | | | btm; floating oil | | | | | | |
| 2A | 2 | UF | 2 | Permeate | Clear yellow | 2.2 | 11 | 27.9 | NA | NA | 0.4 |
| 3B | 2 | UF | 2 | Feed - | Clear, dark | 1.7 | 8.3 | 28.3 | NA | NA | 8.1 |
| | | | | Retentate | yellow, black | | | | | | |
| | | | | | solid on btm; | | | | | | |
| | | | | | floating oil | | | | | | |
| 3A | 2 | UF | 2 | Permeate | Clear yellow | 2.0 | 9.9 | 27.7 | NA | NA | 0.4 |
| 4A | 2 | UF | 1 | Permeate | Clear yellow | 2.1 | 10.4 | 27.5 | NA | NA | 0.5 |
| 4B | 2 | UF | 1 | Retentate | ˜Clear, yellow, | 1.6 | 7.8 | 28.6 | NA | NA | 12 |
| | | | | | black solid on | | | | | | |
| | | | | | btm; floating oil | | | | | | |
| 5A | 2 | UF | 2 | Permeate | Clear yellow | 2.2 | 11 | 29.6 | NA | NA | 0.4 |
| 5B | 2 | UF | 2 | Feed - | Clear, dark | 1.9 | 9.4 | 31.3 | NA | NA | 6.5 |
| | | | | Retentate | yellow, black | | | | | | |
| | | | | | solid on btm; | | | | | | |
| | | | | | floating oil | | | | | | |
| 6B | 2 | UF | 1 | Retentate | Clear, dark | 1.5 | 7.4 | 28.7 | NA | NA | 7.9 |
| | | | | | yellow, black | | | | | | |
| | | | | | solid on btm; | | | | | | |
| | | | | | floating oil | | | | | | |
| 6A | 2 | UF | 1 | Permeate | Clear yellow | 1.9 | 9.7 | 26.6 | NA | NA | 0.5 |
| 7A | 2 | UF | 1 | Permeate | Clear yellow | 1.6 | 8.1 | 23.1 | NA | NA | 0.5 |
| 7B | 2 | UF | 1 | Retentate | ˜Clear, yellow, | 1.2 | 6 | 24.2 | NA | NA | 12.5 |
| | | | | | black solid on | | | | | | |
| | | | | | btm; floating oil | | | | | | |
| 8B | 2 | UF | 2 | Feed - | Clear, dark | 2.1 | 10.5 | 34.4 | NA | NA | 7 |
| | | | | Retentate | yellow, black | | | | | | |
| | | | | | solid on btm; | | | | | | |
| | | | | | floating oil | | | | | | |
| 8A | 2 | UF | 2 | Permeate | Clear yellow | 2.7 | 13.4 | 32.9 | NA | NA | 0.4 |
| 9B | 2 | UF | 1 | Retentate | Clear, dark | 1.2 | 6.2 | 25.5 | NA | NA | 15 |
| | | | | | yellow, black | | | | | | |
| | | | | | solid on btm; | | | | | | |
| | | | | | floating oil | | | | | | |
| 9A | 2 | UF | 1 | Permeate | Clear yellow | 1.7 | 8.7 | 24.2 | NA | NA | 0.4 |
| 10B | 2 | UF | 1 | Retentate | Clear, dark | 1.3 | 6.6 | 26.1 | NA | NA | 14 |
| | | | | | yellow, black | | | | | | |
| | | | | | solid on btm; | | | | | | |
| | | | | | floating oil | | | | | | |
| 10A | 2 | UF | 1 | Permeate | Clear yellow | 1.6 | 8.2 | 24.7 | NA | NA | 0.4 |

The concentration of non-ionic surfactant for Comparative Example 1 decreased to nearly zero in the ultrafiltration permeate for both Stages and both UF units. The concentration of the non-ionic surfactant in the retentate was correspondingly 20-30 times higher than in the permeate, as determined using standard non-ionic surfactant titration method.

The same procedure was performed with Example 1, which contained no non-ionic surfactant. The amount of phosphorus present indicates the relative amount of the phosphate or phosphonate present in the cleaner, permeate or retentate. Likewise, the amount of sulfur present indicates the relative amount of amphoteric surfactant present in these liquids, see Table 5.

TABLE 5
Example 1

| | | | | | | | | | | | Nonionic |
|---|---|---|---|---|---|---|---|---|---|---|---|
| | | | | | | CALC | | | | | Surfactant |
| CLEANER/ | | | UF | UF/Coalescer | | CLEANER | FA (10 ml | TA (10 ml | P | S | Titration. |
| CHEMICAL | STAGE | UF | UNIT | Stage | APPEARANCE | CONC. | sample) | sample) | (ICP) | (ICP) | (ml) |
| Baseline | 1 | NA | NA | NA | Clear yellow, | 2.5 | 10.7 | 16.6 | 1700 | 62 | NA |
| 11 | | | | | black solid on | | | | | | |
| | | | | | btm | | | | | | |
| Baseline | 2 | NA | NA | NA | Clear colorless, | 2.0 | 8.7 | 12.1 | 1240 | 45 | NA |
| 11 | | | | | sl black solid | | | | | | |
| 11A | 2 | UF | 2 | Permeate | Clear, lt yellow | 1.8 | 7.6 | 11.7 | 1210 | 47 | NA |
| 11B | 2 | UF | 2 | Retentate | Clear, lt | 1.6 | 7 | 12.5 | 1570 | 51 | NA |
| | | | | | yellow, black | | | | | | |
| | | | | | solid on btm | | | | | | |
| Baseline | 1 | NA | NA | NA | Dark yellow, bl | 2.2 | 9.2 | 18.5 | NA | NA | NA |
| 21 | | | | | solid on btm; | | | | | | |
| | | | | | floating oil | | | | | | |
| | | | | | (Before turning | | | | | | |
| | | | | | on) | | | | | | |
| Baseline | 2 | NA | NA | NA | Dark yellow, bl | 1.4 | 5.9 | 11.2 | NA | NA | NA |
| 21 | | | | | solid on btm; | | | | | | |
| | | | | | floating oil | | | | | | |
| | | | | | (Before turning | | | | | | |
| | | | | | on) | | | | | | |
| 21B | 2 | UF | 2 | Feed - | Clear, dark | 1.1 | 4.5 | 10.5 | 1510 | 42 | NA |
| | | | | Retentate | yellow, much bl | | | | | | |
| | | | | | solid on btm; | | | | | | |
| | | | | | floating oil | | | | | | |
| 21A | 2 | UF | 2 | Permeate | Clear, lt yellow | 1.2 | 5.1 | 9.3 | 1010 | 38 | NA |
| 22A | 2 | UF | 1 | Permeate | Clear, lt yellow | 1.3 | 5.5 | 8.5 | 762 | 37 | NA |
| 22B | 2 | UF | 1 | Retentate | Clear, lt yellow, | 1.2 | 5.1 | 10 | 1120 | 40 | NA |
| | | | | | black solid on | | | | | | |
| | | | | | btm | | | | | | |
| 31B | 2 | UF | 2 | Feed - | Clear dark | 0.9 | 4 | 10.3 | 1440 | 38 | NA |
| | | | | Retentate | yellow, black | | | | | | |
| | | | | | solid on btm | | | | | | |
| 31A | 2 | UF | 2 | Permeate | Clear lt yellow | 0.9 | 4 | 8.7 | 930 | 35 | NA |
| 32A | 2 | UF | 1 | Permeate | Clear lt yellow | 1.0 | 4.3 | 8.7 | 810 | 36 | NA |
| 32B | 2 | UF | 1 | Retentate | Clear lt yellow, | 1.0 | 4.3 | 9.8 | 1270 | 38 | NA |
| | | | | | black on btm | | | | | | |
| 33B | 2 | UF | 1 | Retentate | Clear, lt yellow, | 1.1 | 4.5 | 11.5 | NA | NA | NA |
| | | | | | black solid on | | | | | | |
| | | | | | btm; sl floating | | | | | | |
| | | | | | oil | | | | | | |
| 33A | 2 | UF | 1 | Permeate | Clear, lt yellow | 1.2 | 5 | 10 | NA | NA | NA |
| 34A | 2 | UF | 2 | Permeate | Clear, lt yellow | 1.2 | 5.2 | 12.7 | NA | NA | NA |
| 34B | 2 | UF | 2 | Feed - | Clear yellow, bl | 1.2 | 5 | 13.7 | NA | NA | NA |
| | | | | Retentate | solid on btm; | | | | | | |
| | | | | | floating oil | | | | | | |
| Baseline | 1 | NA | NA | NA | Clear yellow, | 1.6 | 6.7 | 22.3 | 2290 | 91 | NA |
| 41 | | | | | black solid on | | | | | | |
| | | | | | btm; floating oil | | | | | | |
| Baseline | 2 | NA | NA | NA | Clear yellow, | 1.4 | 6 | 14 | 1290 | 50 | NA |
| 41 | | | | | black solid on | | | | | | |
| | | | | | btm; floating oil | | | | | | |
| 41B | 2 | UF | 2 | Feed - | Clear dk yellow, | 1.3 | 5.4 | 14.1 | 1700 | 54 | NA |
| | | | | Retentate | brown solid on | | | | | | |
| | | | | | btm; floating oil | | | | | | |
| 41A | 2 | UF | 2 | Permeate | Clear lt. Yellow | 1.3 | 5.6 | 12.7 | 1340 | 50 | NA |
| 42B | 2 | UF | 1 | Feed - | Sl cloudy, dark | 0.9 | 4 | 13.7 | 1630 | 59 | NA |
| | | | | Retentate | yellow, bl solid | | | | | | |
| | | | | | on btm; floating | | | | | | |
| | | | | | oil | | | | | | |
| 42A | 2 | UF | 1 | Permeate | Clear, lt yellow | 1.2 | 5 | 12.4 | 1320 | 48 | NA |

The amphoteric surfactant passes substantially 100% through the membranes of the UF units, as evidenced by similar ICP sulfur numbers in both the permeate and the retentate samples.

Some of the CRS metal panels had smut on the surfaces prior to cleaning. Samples of each cleaner were placed in stirred beakers and the smutty panels were placed in the beakers. Example 1 appeared to clean more of the smut from the surfaces than Comparative Example 1. Both cleaners were observed to split in a commercially available oil coalescer device. Example 1 split more rapidly than Comparative Example 1. The used Stage 2 cleaner for Example 1 was observed to split out oil in the Stage 2 tank when agitation was ceased.

1. A stable, aqueous, alkaline cleaner concentrate composition comprising:
(a) an alkalinizing agent in an amount of at least 1 mole of hydroxide per kilogram of total concentrate composition;
(b) an anionic surfactant;
(c) an amphoteric surfactant;
(d) a sequestering agent and/or a chelating agent;
(e) a phosphate builder; and
(f) optionally, an antifoam agent
wherein each of components (a) to (f) in aqueous solution is charged and able to pass substantially completely through a filter membrane having a pore size of 0.005 to 0.15 microns.

2. The stable, aqueous, alkaline cleaner concentrate composition according to claim 1 wherein said amphoteric surfactant comprises at least one of sulfonated wetting agents, imidazoline-based amphoteric molecules, betaines, sultaines, and mixtures thereof.

3. The stable, aqueous, alkaline cleaner concentrate composition according to claim 1 wherein said sequestering agent is selected from the group consisting of organophosphonates, sorbitol, mannitol, gluconates, citrates, heptogluconates, ethylene diamine tetraacetic acid, nitrilotriacetic acid and mixtures thereof.

4. The stable, aqueous, alkaline cleaner concentrate composition according to claim 1 wherein said alkalinizing agent is an alkali metal hydroxide, said anionic surfactant is a modified ethoxylated anionic surfactant, and said amphoteric surfactant is a sultaine.

5. The stable, aqueous, alkaline cleaner concentrate composition according to claim 1, having sufficient solubility of (a) to (f) in aqueous solution of up to 25% free alkalinity such that a one-package liquid concentrate is stable for at least 3 months.

6. The stable, aqueous, alkaline cleaner concentrate composition according to claim 1 comprising:
(a) said alkali metal hydroxide alkalinizing agent in an amount of 1.5 to 5.0 mole of hydroxide per kilogram of total concentrate composition;
(b) said anionic surfactant in an amount of 0.5 to 20 wt %
(c) said amphoteric surfactant in an amount of 0.5 to 20 wt %
(d) said sequestering agent and/or chelating agent in an amount of 0.1 to 20 wt %;
(e) said phosphate builder in an amount of to 2 to 30 wt %; and
(f) optionally, an antifoam agent.

7. A working cleaner bath made-up by adding the alkaline cleaner composition concentrate of claim 6 to water in an amount sufficient to provide said bath with 0.5 to 10.00 wt % concentration of the alkaline cleaner composition concentrate.

8. A stable, aqueous, alkaline cleaner composition comprising:
(a) an alkali metal hydroxide alkalinizing agent in an amount sufficient to provide the total composition with a pH greater than 8;
(b) an anionic surfactant;
(c) an amphoteric surfactant:
(d) a sequestering agent and/or a chelating agent;
(e) a phosphate builder; and
(f) optionally, an antifoam agent;
wherein said anionic surfactant is a modified ethoxylated anionic surfactant, said amphoteric surfactant is a sultaine and (b) to (c) are present in a ratio in the range of 3:6 to 2:1.

9. The stable, aqueous, alkaline cleaner composition of claim 8 comprising:
(a) an alkali metal hydroxide alkalinizing agent in an amount of 0.07 to 4.0 moles of hydroxide per kilogram of total concentrate composition;
(b) an anionic surfactant in an amount of 0.03 to 4.0 wt %;
(c) an amphoteric surfactant in an amount of 0.04 to 6.5 wt %:
(d) a sequestering agent and/or a chelating agent in an amount of 0.06 to 7.5 wt %;
(e) a phosphate builder in an amount of 0.15 to 17.0 wt %.

10. The stable, aqueous, alkaline cleaner composition of claim 8, wherein said amphoteric surfactant comprises at least one of sulfonated wetting agents, imidazoline-based amphoteric molecules, betaines, sultaines, and mixtures thereof.

11. The stable, aqueous, alkaline cleaner composition of claim 8, wherein said sequestering agent is selected from the group consisting of organophosphonates, sorbitol, mannitol, gluconates, citrates, heptogluconates, ethylene diamine tetraacetic acid, nitrilotriacetic acid and mixtures thereof.

12. The stable, aqueous, alkaline cleaner composition of claim 8, wherein said alkalinizing agent is an alkali metal hydroxide, said anionic surfactant is a modified ethoxylated anionic surfactant, and said amphoteric surfactant is a sultaine.

13. A cleaning system comprising:
1) a cleaner bath containing an alkaline cleaner comprising:
(a) an alkali metal hydroxide alkalinizing agent in an amount of at least 0.35 mole of hydroxide per kilogram of total concentrate composition;
(b) an anionic surfactant;
(c) an amphoteric surfactant;
(d) a sequestering agent and/or a chelating agent;
(e) a phosphate builder; and
(f) optionally, an antifoam agent;
2) a filter membrane in fluid communication with said cleaner bath, having a pore size of 0.005 to 0.15 microns, through which said alkaline cleaner passes thereby generating a permeate and a retentate;
wherein said surfactants are selected such that permeate surfactant concentration is at least 50% of retentate surfactant concentration at a given point in time after at least a portion of said alkaline cleaner has been filtered.

14. The cleaning system of claim 13, further comprising a permeate receiving unit and a retentate receiving unit.

15. The cleaning system of claim 13, wherein said surfactants are selected such that permeate surfactant concentration is at least 70% of retentate surfactant concentration at a given point in time after at least a portion of said alkaline cleaner has been filtered.

16. The cleaning system of claim 13, wherein said amphoteric surfactant comprises at least one of sulfonated wetting agents, imidazoline-based amphoteric molecules, betaines, sultaines, and mixtures thereof.

17. The cleaning system of claim 13, wherein said sequestering agent is selected from the group consisting of organophosphonates, sorbitol, mannitol, gluconates, citrates, heptogluconates, ethylene diamine tetraacetic acid, nitrilotriacetic acid and mixtures thereof.

18. The cleaning system of claim 13, wherein said alkalinizing agent is an alkali metal hydroxide, said anionic surfactant is a modified ethoxylated anionic surfactant, and said amphoteric surfactant is a sultaine.
